(19) United States
(12) Patent Application Publication
(10) Pub. No.: US 2026/0087942 A1
(43) Pub. Date: Mar. 26, 2026

(54) Mechatronic arm system for engineering education

(71) Applicant: Leendert Albert Schrader, Saint Louis, MO (US)

(72) Inventor: Leendert Albert Schrader, Saint Louis, MO (US)

(21) Appl. No.: 18/892,947

(22) Filed: Sep. 23, 2024

(51) Int. Cl. G09B 23/00; B25J 11/00

(52) U.S. Cl. CPC G09B 23/00; B25J 11/00

(57) ABSTRACT

The present invention encapsulates the design and construction of a mechatronic arm system with the express purpose of the construction and operation being used as an educational tool to instruct on various principles in mechanical, electrical, and computer engineering. The components of the mechanical frame are manufactured of 3D printed PLA plastic and are combined with a stepper motor and four servo motors alongside a set of screws and nuts to assemble the main structure. The electronic modules are to be assembled by placing them on pins of a solderless breadboard with jumper wires used for inter-module connection. The components of the present invention are specifically tailored for an educational experience, one which is particularly beneficial in an instructor-student classroom setting wherein the instructor may utilize the invention to optimally and interactively portray valuable lessons in interdisciplinary engineering at variable complexities.

### PRIOR ART

U.S. Pat. No. 11,148,295B2: Systems, devices, components, and methods for a compact robotic gripper with palm-mounted sensing, grasping, and computing devices and components.
Patent No. KR20200137638A: Student manual for robot production education.
Patent No. KR101520737B1: Robot simulator teaching device with disassembling and assembling.

### BACKGROUND OF THE INVENTION

The current state of technology is one where most systems require more than a single engineering discipline's contribution, with mechatronics being one of the most economically substantial. The rapidly growing market of mechatronics is mainly focused on bringing innovative solutions to industry (manufacturing, construction, agriculture, etc.); the field itself incorporates important aspects of mechanical, electrical, and computer engineering. Although mechatronic systems such as the conventional mechatronic arm would be of high value as an educational tool due to their interdisciplinary nature, the purely industrial application and rapidly increasing complexity leaves little room for interactive educational activities for students of engineering. This complexity is highlighted by U.S. Pat. No. 111,482,95B2 containing a novel design of a robotic gripper with the implementation of a plurality of sensors and actuators, the application of which is likely to confuse those without direct experience in robotics/mechatronics and as such is unsuitable for an introductory educational environment. Mechanical frames and gears are often made of expensive high-quality steel or cast iron for industrially optimized controls and power transmission. Furthermore, the functions and integration of associated electronics tend to be nebulous for the sake of creating compactness and/or aesthetic form. This convolution of an invaluable interdisciplinary educational resource can lead to the average engineering student not receiving the necessary exposure to problems that will be faced in the current world's technological goals, consequently leading to an unprepared workforce. In related art such as Patent No. KR101520737B1, the assembly and disassembly of one feature of the device, the power lock, is described by the inventors as “not suitable for use as a simulator device because the device is complicated and disassembling and assembling is not easy. ” In this case, we see the complexity of the device acting as a barrier preventing a user from achieving the full educational value of the invention. On the opposite end of the complexity spectrum, Patent No. KR20200137638A describes a detailed manual invented for students to be able to construct a simple mobile robot and apply a range of programs to observe how it impacts the robot's functionality. However, the robot being constructed is of little relation to actual mechatronic systems used in industry and therefore falls short in an important portrayal of real-world application. A clear and pertinent flaw that both previously mentioned Patent No. KR101520737B1 and Patent No. KR20200137638A contain is the inaccessibility to system electronics. Mechatronics as a field necessitates knowledge of electrical engineering principles, yet the current state of technology in devices used for mechatronics education restricts this interaction with electrical components. One does not create systems of this caliber with only knowledge of its mechanical frame or only its programming, and as such it is unrealistic to expect students to gain a comprehensive education on interdisciplinary engineering principles without exposure to every facet of the mechatronic system being assembled. To further stimulate the growth of the field of mechatronics and to bring a richer, fuller education to students in engineering disciplines, affordable access to a mechatronic system that clearly and interactively displays interdisciplinary principles of engineering while still retaining an appropriately engaging complexity serves as a valuable resource to educate future generations of engineers.

### SUMMARY OF THE INVENTION

The invention is an easily assembled and disassembled mechatronic arm comprised of a 3D printed mechanical frame of PLA secured with M4, M3, and M2.5 screws with four integrated servo motors and an integrated stepper motor controlling five degrees of freedom and a pre-wired breadboard with implantable and removeable printed circuit boards and microcontrollers with a USB-C communication port for easy-access user programming. An instructional manual exists detailing the assembly and disassembly of the mechanical and electrical components and wire connections for controller-to-motor communication. The low cost of materials and commercial accessibility of replacement parts removes a barrier of cost in conventional constructable mechatronic arm systems. Similarly, the intuitive construction of the pieces comprising the mechanical frame exists as an effective way to portray principles of mechanics and mechanical interactions especially when paired with an appropriate instructional manual that follows the assembly process. The construction of electronic components allows one insight into electrical circuit creation and controls while accentuating the necessity of collaboration between mechanical and electrical engineering in an interactive manner. In a similar fashion, allowing users to easily observe and customize the programming of the mechatronic arm assimilates yet another major engineering field, computer engineering, into the educational repertoire of the construction process. Intentional, minor faults are incorporated into the mechanical frame as to stimulate the constructor's problem-solving skills via conceptual improvements, of which can be emphasized by a post-construction questionnaire requiring responses that detail how one would further innovate on the design for heightened security, stability, and/or control of the robot. The invention excels in an instructor-student class environment, as it facilitates an interactive experience in interdisciplinary engineering while allowing the instructor to alter the complexity of the construction as necessary and actively address the engineering principles being conveyed by the invention. The markedly low production costs due to material choice, open access to mechanical and electrical components, ease of programmability, intentional flaws to more effectively educate on multidisciplinary engineering principles, variable complexity, and the intuitive assembly/disassembly all serve to benefit the builder's educational experience without requiring significant effort from the instructor/facilitator.

### BRIEF DESCRIPTION OF DRAWINGS

FIG. 1: isometric view of all mechanical components.

FIG. 2: front view of all mechanical components.

FIG. 3: side view of all mechanical components.

FIG. 4: top view of all mechanical components.

FIG. 5: exploded isometric view of all mechanical components. The 3D printed components of the claw mechanism remain unexploded for structural clarity.

FIG. 6: isometric view of strictly the 3D printed components.

FIG. 7: exploded top view of the 3D printed components of the claw mechanism.

FIG. 8: exploded isometric view of the 3D printed components of the claw mechanism.

FIG. 9: exploded isometric view of the 3D printed base and base joint components with base screws for detailed feature annotation.

FIG. 10: exploded isometric view of the 3D printed secondary and wrist joints with assembly screws and servos for detailed feature annotation.

FIG. 11: isometric view of the unwired electronics.

FIG. 12: electronics wiring diagram.

### DETAILED DESCRIPTION OF THE INVENTION

The following describes the composition of the mechatronic arm, and the components required prior to the construction process:

The mechanical frame of the mechatronic arm is comprised of the low base (31), base cap (32), base joint (33), two primary joint arms (34), 4-hole arm bind (35), secondary joint non-servo arm (36), secondary joint servo arm (37), 1-hole arm bind (38), wrist joint (39), three joint pins (41) and pin ends (42), claw base (51), two geared hinges (52), two ungeared hinges (53), and two claw grips (54), all of which are manufactured from PLA plastic via 3D printing. Movement is performed by four MG996R servo motors with circular horns and 11 kg/cm stall torques (1) and a singular NEMA 17 stepper motor (2) with a 5 mm universal mounting hub (19). Four ½ inch stainless steel bearing balls (10) are used for friction reduction in the base joint rotation. The electronics are comprised of a 400-pin solderless breadboard (202), Arduino Nano microcontroller with USB-C interface (203), A4988 stepper motor driver (206), 12V to 6V buck converter (207), PCA9685 16-port servo motor driver (205), 12V battery (201), and a minimum of 26 jumper wires following FIG. 12. A total of twelve M4 20 mm (20), eight M4 12 mm (21), sixteen M3 12 mm (22), seven servo horn screws, and three M2.5 16 mm screws (5) with seven M4, eight M3, and three M2.5 nuts are needed for appropriately securing the frame and motors. Servo wire extenders, though not necessary for full functionality, can be connected to the servo motors to ensure the robot maintains rotational capabilities unrestricted by wire length.

The following describes the assembly process of the mechatronic arm's mechanical components in detail wherein the term “mechanical” implies any component used in maintaining or rotating the structure of the arm which includes the 3D printed frame, motors, screws, and nuts:

The stepper motor is situated in the square extrusions of the low base (101). The base cap is then lined up with the stepper motor shaft by inserting the shaft through the central hole of the base cap (113). The four square-patterned holes (112) and three outer holes (113) of the base cap are lined up with the stepper motor's topside holes and the three holes of the low base (102) respectively. Using three M4 20 mm screws, the base cap is coupled to the low base via the lined up outer holes. Four ½ inch steel bearing balls are placed in the four hollow compartments on the underside of the base joint (121). This base joint assembly is next placed concentric to the base cap, lining up the central hole with the stepper motor shaft. The 5 mm universal mounting hub is placed over the motor shaft and secured to the base joint with two M3 12 mm screws coupling the mounting hub and base joints squarely placed inner holes. A third M3 12 mm screw is used to tension the mounting hub to the stepper motor shaft. A servo motor is then secured to the base joint column with the larger diameter hole (122) using four M3 12 mm screws.

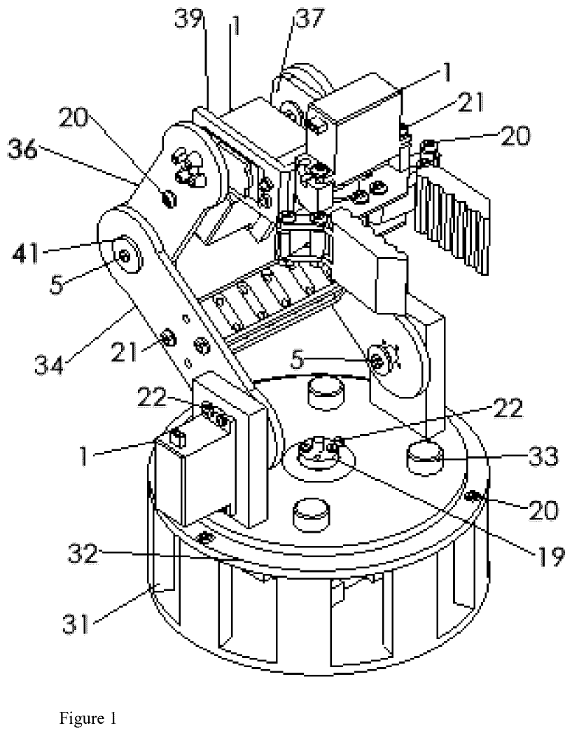

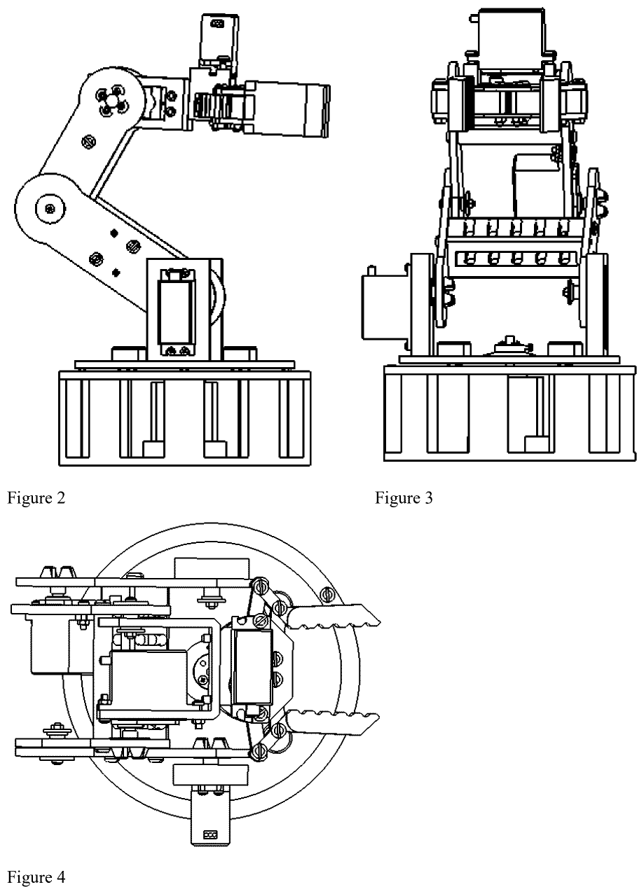

The cylindrical horn of the servo is attached to the horn coupling cut (131) on the primary joint arm, of which is then placed on the rotational end of the secured servo motor. The second primary joint arm is rotated 180 degrees relative to the already secured primary joint arm and is held on the outside of the opposite column of the base joint by insertion of a joint pin through the base joint pinning hole (124) and primary joint arm pinning hole (133), in that order. The joint pin cap is then secured to the end of the joint pin using an M2.5 16 mm screw and M2.5 nut. To mate the movement of both primary joint arms, the 4-hole arm bind is placed in between both primary joint arms with the squared holes of the bind (143) and primary joint arms (132) being made concentric, after which four M4 12 mm screws are inserted, two on each outer plane of a particular primary joint arm, in a diagonal fashion as shown in FIG. 1 and FIG. 2. A second cylindrical servo horn is then attached to the available horn coupling cut on the primary joint arm secured by the joint pin and cap.

A servo motor is secured to the secondary joint servo arm's servo insert (174) with the motor positioned in a way such that the rotational end is at an utmost distance from the joint pinning hole. The motor is secured with four M3 12 mm screws and four M3 nuts. The rotational end of the secured servo is then attached to the available cylindrical servo horn of the appropriate primary joint arm. A cylindrical servo horn is attached to the horn coupling cut of the secondary joint non-servo arm. A joint pin, cap and M2.5 16 mm screw with an M2.5 nut are used to hold the secondary joint non-servo arm concentric with the joint pinning hole of the servo-coupled primary joint arm. To mate the movements of the secondary joint arms, the 1-hole arm bind is placed concentric to both central holes of the arms (151) and held together by two M4 20 mm screws inserted as seen in FIGS. 1-4.

In a similar fashion to the secondary joint non-servo arm, a servo is secured to the wrist joint via four M3 12 mm screws and M3 nuts applied through the securing holes (173). The rotational end of the servo should be at the utmost distance from the bridge connection of the wrist joint housing two screw holes (171). The wrist joint is bound to the overall structure by the rotational end of the servo connecting to the available cylindrical horn of the secondary joint arm, as well as by a joint pin and cap assembly holding the structure by the wrist pinning hole (172) and other secondary joint arm's pinning hole similarly to the joint pinning method used twice prior.

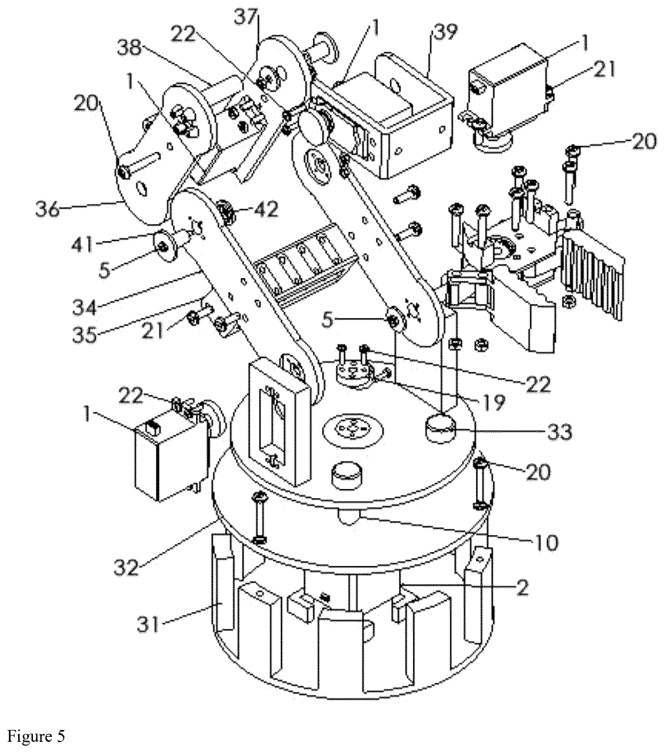

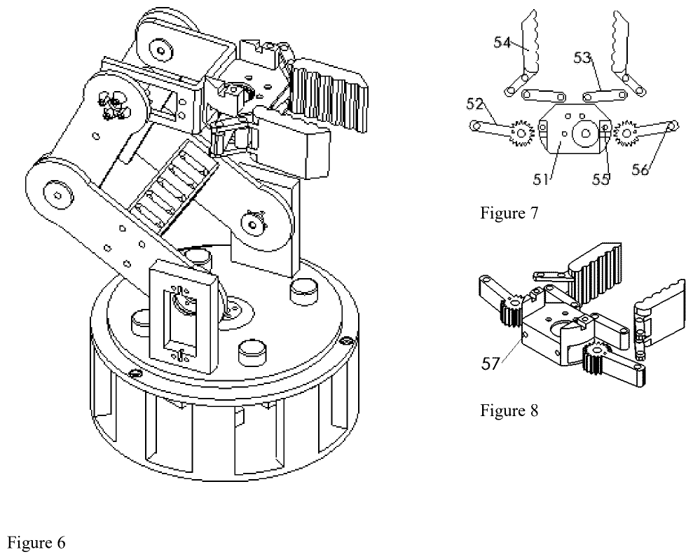

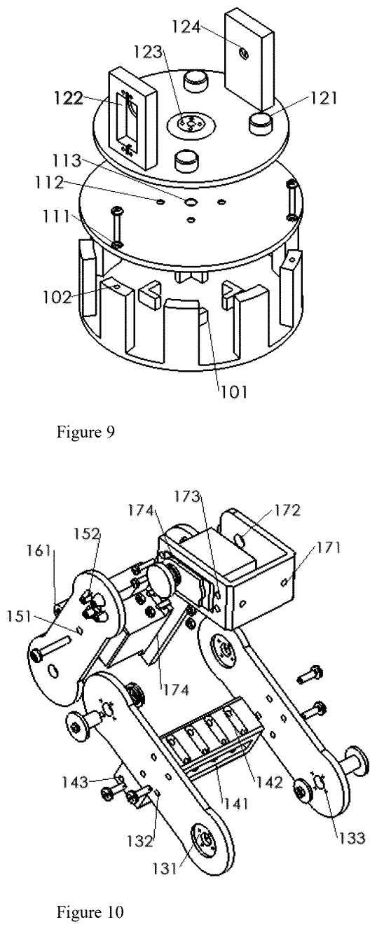

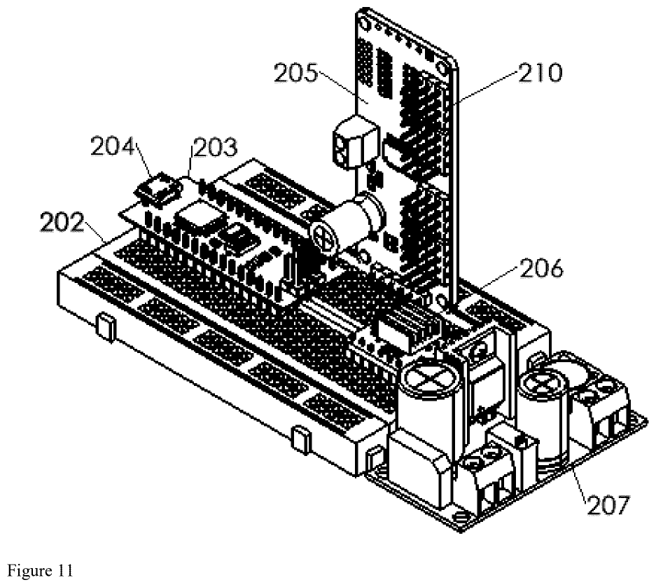

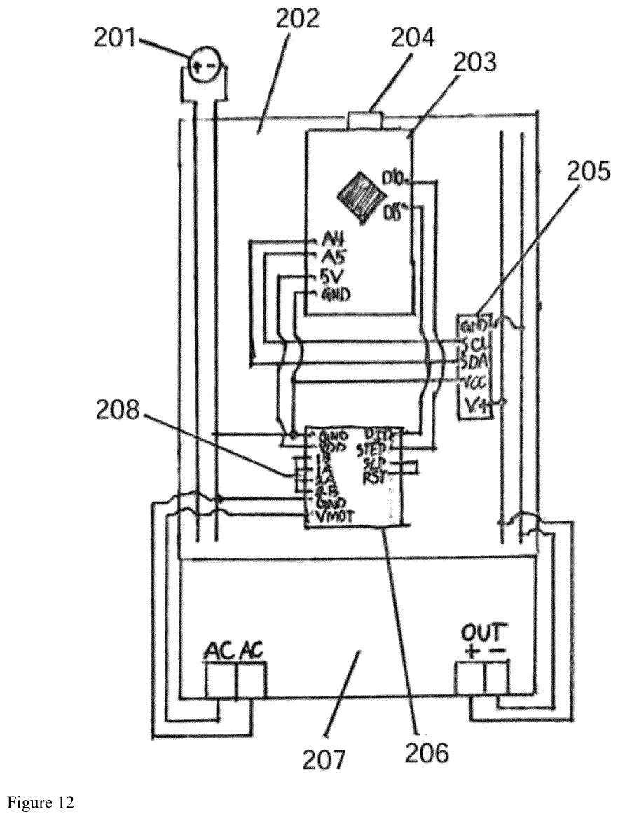

Following the assembly of the wrist structure, the claw base is coupled to the wrist joint bridge holes (171) by two M4 12 mm screws being first inserted through the claw coupling holes (57). A geared hinge is placed concentric to the largest diameter hole of the claw base internally, and a cylindrical servo horn is subsequently attached to the geared hinge by a servo horn screw inserted through the horn and smallest diameter hole of the geared hinge. The second ungeared hinge is placed concentric to the hole of the claw base immediately to the left of the largest diameter hole using FIG. 7 as a reference. An M4 20 mm screw is inserted through the lined-up holes of the claw base and geared hinge to restrict the hinge's movement. An M4 nut is used to secure the screw. The final servo motor is placed on the topside of the claw base with the rotational center attaching to the cylindrical horn bound to the unsecured geared hinge. An M3 12 mm screw is then tightened into the rotational center of the servo from the underside of the claw base. The servo is restrained by two M4 12 mm screws inserted through the servo mounting holes on the claw base (55). Following the assembly of the geared hinges and servo with the claw base, two ungeared hinges are placed respectively in one of the remaining two claw base holes and secured the same as the prior geared hinge: an M4 20 mm screw inserted through the lined-up holes and held with an M4 nut. The two claw grips are positioned with parallel faces and with the ridged sides facing each other. Each claw grip is placed such that the two holes are lined up with one geared hinge end (56) and one ungeared hinge end, with the furthermost claw grip hole from the part's center being lined up with the geared hinge end. For each claw grip, two M4 screws and associated M4 nuts are used to restrict movement; FIG. 4 portrays a proper view of the secured claw.

The following details the assembly of the mechatronic arm's electronic components in detail wherein the term “electronic” refers to any component involved in the execution of motor control and/or which is necessary to facilitate inter-controller communication which includes the breadboard, motor drivers, battery, voltage buck converter, microcontroller, and jumper wires:

The organization/placements of the microcontrollers and printed circuit boards are referenced on a half-length conventional solderless breadboard consisting of columns marked by letters a-j and rows numbered 1-30 as well as four vertical 30-point power rails connected by column. The top left (D13) and bottom right (D0) corner pins of the Arduino Nano microcontroller are placed on breadboard pins d1 and h15 respectively, wherein the initial letter indicates the column, and the following number indicates the row on the breadboard. The PCA9685 servo driver is placed on pins j17-j22 with the GND connection being in breadboard pin j17 as an orientation reference. The top left (GND) and bottom right (EN) corner pins of the A4988 stepper motor driver are placed in breadboard pins d23 and g30 respectively. The 12V to 6V buck converter is wired such that the voltage input connects from the leftmost power rails and voltage output connects to the rightmost power rails with OUT+ connecting to the “+” rail and OUT− connecting to the “−” rail as oriented by FIG. 12. General wiring is done following FIG. 12; however, the connection of the 12V battery shall be the final step in the assembly process. The NEMA 17 stepper motor is connected to the stepper motor driver by pins 1B, 1A, 2A, 2B (208) with the output wires of the stepper motor corresponding directly with these pin names. Prior to connecting the servo motors and driver, a servo wire extender can be connected to each servo motor's output wires to increase the distance between the mechanical and electronic components. The output pins of the servo motor controlling the primary joint arm rotation is connected to the servo driver's 13^{th} servo input row. Output pins of the motor controlling the secondary joint arm rotation connect to the 14^{th} servo driver input row; the wrist rotation motor connects to the 15^{th} driver input row; the claw opening/closing motor connects to the 16^{th} driver input row. Servo motor pins and servo driver input pins are to be color coordinated during connection. Rows 13-16 of the servo driver (210) are oriented such that row 13 is closest to the breadboard and row 16 is at the utmost distance from the breadboard. Upon the proper assembly and connection of the mechanical and electronic components as described, the 12V battery is then connected to the leftmost power rail according to FIG. 12, of which the system can be freely programmed via the Arduino Nano's USB-C communication port (204) and Arduino IDE compatible device.

The following details particular features of the invention's components and assembly that make the invention particularly suited as an educational utility:
1) The nature of the mechanical frame being 3D printed effectively displays cost efficiency and how the choice of material can heavily influence the quality and precision of manufactured parts.
2) The fact that the device is a mechatronic arm, which are devices widely used in industry for a multitude of broad applications, implies a far higher relevance of the benefits of understanding the system as opposed to the device described in Patent No. KR20200137638A.
3) The use of both stepper and servo motors together educates on the necessity for using specialized tools to perform specific tasks with higher efficiency.
4) The half-conic material surrounding the servo horn binding holes (152) displays how material strength can be optimized in small but impactful ways, with the main concept portrayed being how the higher surface contact reduces the possibilities of shearing and increases load-bearing capabilities.
5) The unused holes in the 4-hole bind display the possibilities for design improvement by reducing material and space usage while also educating on the minimum number of secured points as to be an effective bind.
6) The principle of restricted movement discussed in the prior statement is elaborated on with the 1-hole bind being ineffective at restricting rotation of the bind. The binds therefore educate on the concepts of both over-engineering and under-engineering a component, as neither optimally hold the solution to proper motion restriction in the arm. As such, said optimal solution can be positioned as an activity for the user to design themselves.
7) The claw mechanism enunciates the principle in dynamics of related motion through use of the two hinges (geared and ungeared) manufactured at lengths such that the claw grip faces remain parallel through the entire opening-closing movement. The opportunity to construct the components necessary to facilitate this motion grants users an opportunity to understand and employ these principles beyond through theoretical analysis.
8) The diagonal placement of screws as utilized in the securing of the 4-hole bind and 5 mm universal mounting stimulate the user to think on why securing a component with screws at the utmost distance from each other is optimal as opposed to placing them closer together in these scenarios.
9) Components can be pre-assembled prior to a user's assembly experience: this variable complexity allows the invention to be uniquely beneficial for a particular user's age or level of experience.
10)Assembling the electronics offers unique hands-on experience with the interaction of electronic modules, of which the individual inter-module connections can be seen by the general breadboard wiring.
11)In current technology, electrical systems are often left out of the educational experience due to their high complexity: this invention interactively displays the electrical systems in a digestible manner.
12)The breadboard being solderless allows for ease of correction in case of an improper wire or module placement.
13)The use of both stepper and servo motor drivers accentuates the concept that different control methods are often necessary for different utilities, implying sacrifices in cost for complexity and/or optimization.
14)Utilizing a buck converter as opposed to a separate 12V and 6V battery restricts the design to just a singular power source, therefore allowing the user to observe another source of cost efficiency while also acting to improve safety (handling one power source being safer than needing to handle two).
15)The use of a buck converter emphasizes the electrical concept of Ohm's law: by dropping the voltage from 12V to 6V and assuming the change in resistance is negligible, more current can be safely drawn by the servo motors thus granting them more power and control over movement.
16)The open access to a USB-C port for programming replaces the original Arduino Nano's micro-USB port with one that is notably more accessible and widely used.
17)The aforementioned open access allows users to observe and execute pre-loaded code or create their own programs to understand the full scope of the invention, implementing a valuable resource for learning computer/microcontroller programming in the invention.
18)The inventions interdisciplinary nature offers the opportunity to educate on higher complexity topics in mechanical engineering including but not limited to inverse kinematics and broader statics/dynamics theory, power transmission via gear relations, and materials strength, while similarly standing as a utility to further instruct on topics in electrical engineering including but not limited to circuits, power transmission via electrical energy, and electromagnetism via stepper/servo motor operation, and topics in computer engineering including but not limited to communication protocols (Serial and I2C), microprocessors/microcontrollers, and object-oriented programming.

The features contributing to the invention's educational utility are vast and can be arbitrarily abstracted; as such, the listing above is not the limit of the entirety of the educational utility provided by the invention.

1. A mechatronic arm of which:
The mechanical frame which comprises all components necessary for the structure of the arm and excluding the screws, nuts, motors, and mounting hub is 3D printed and is assembled and disassembled when paired with the excluded components with an instructional manual detailing the assembly process,
Components of the mechanical frame are purposefully created with flaws with the intent that said flaws be used to educate on why their designs are not advantageous comparable to an already known, more effective design and of which are not significantly debilitating to the movement capabilities such that the system cannot perform structured movements on all degrees of freedom,
Electronic components are assembled and disassembled with the use of an instructional manual and consist of a solderless breadboard, jumper wires, motor drivers, and a microcontroller which serves as the principal unit of program execution,
The accompanying instructional manual actively accentuates the engineering principles attempting to be conveyed by the device's design features at the appropriate steps of the assembly process,
The sole purpose is to be used as a complementary educational tool for conveying mainly concepts in mechanical, electrical, and/or computer engineering in a formal educative setting.

2. The design methodology described in claim 1 wherein the mechanical frame is didactic in introductory mechanical engineering complementary to formal instruction encapsulated by the intentional faults inlaid and the nature of the 3D printed plastic material.

3. The design methodology described in claim 1 wherein the electronic modules, assembly, and exposure is didactic in introductory electrical and computer engineering complementary to formal instruction.

4. The design methodology described in claim 1 wherein the accompanying instructional manual details first the construction of the mechanical components, then the construction of the electronic components, then the integration between both the mechanical and electronic components, and finally the implementation of an arbitrary computer program onto the microcontroller for program execution.
